(19) United States
(12) Patent Application Publication
(10) Pub. No.: US 2026/0343515 A1
(43) Pub. Date: Oct. 29, 2026

(54) BANDWIDTH ALLOCATION IN A TIERED NETWORK

(71) Applicant: Charter Communications Operating, LLC, St. Louis, MO (US)

(72) Inventor: Rauf Hafeez, Cary, NC (US)

(21) Appl. No.: 19/191,195

(22) Filed: Apr. 28, 2025

(51) Int. Cl. H04W 72/0457; H04W 72/541; H04W 72/566

(52) U.S. Cl. CPC H04W 72/0457; H04W 72/541; H04W 72/566

(57) ABSTRACT

A communication management resource monitors use of a wireless channel by a first wireless station. The first wireless station is assigned a highest priority to use available wireless bandwidth. The communication management resource can be configured to receive a request from a second wireless station (having a lower priority than the first wireless station) for allocation of a wireless channel. In response to receiving the request, the communication management resource allocates the second wireless station use of a first wireless channel depending at least in part on a communication configuration (a.k.a., configuration settings indicating a communication rate) implemented by the first wireless station to communicate with the bandwidth management resource. In addition to the configuration settings, the communication management resource can be configured to allocate the second wireless station use of the first wireless channel depending upon a trajectory and speed of the first wireless station.

### BACKGROUND

The CBRS (Citizens Broadband Radio Service) band comprises 150 MHz (MegaHertz) of spectrum in the 3550 MHz to 3700 MHz range (3.5 GHz to 3.7 GHz) that the Federal Communications Commission (FCC) has designated for sharing among three tiers of users: incumbent users, priority access license (PAL) users and general authorized access (GAA) users.

Conventional wireless networks typically include one or more wireless base stations to provide mobile communication devices access to a remote network such as the Internet. One type of wireless base station is a so-called CBSD (Citizen Broadband Radio Service Device). Such a device uses a wireless channel allocated from a CBRS (Citizens Band Radio Service) band to support communications with one or more mobile communication devices.

Typically, so-called SAS (Spectrum Access Service) in a CBRS network allocates one or more wireless channels to a CBSD (such as a wireless base station) to support communications with respective user equipment such as one or more mobile communication devices. Each base station can be configured to communicate with the SAS to receive notification of the one or more wireless channels allocated for its use. Controlled allocation of wireless channels by the spectrum access system helps to prevent interference by wireless stations sharing use of the same spectrum.

As previously discussed, there are multiple different types of wireless channels in a conventional CBRS band. For example, portions of spectrum in a CBRS band include so-called Priority Access License (PAL) wireless channels, General Authorized Access (GAA) wireless channels, or a combination of both.

In general, PAL wireless channels are licensed wireless channels in which a corresponding licensee (such as an entity paying for use of the wireless channel) is provided some protection of use. For example, when no incumbent user requires use of the channels, in theory, the licensed entity is able to freely use the PAL wireless channels in respective one or more predetermined geographical regions without interference by other lower priority entity users (such as lower priority GAA users).

In a CBRS band, a conventional centralized controller called a spectrum access system (a.k.a., SAS) enables sharing of wireless bandwidth by multiple wireless stations operating in the same geographical region via implementation of radio frequency propagation models. Implementation of the wireless signal propagation models protects users and incumbent entities from harmful interference. Incumbent entities are provided highest protection. When they are detected as being present in a geographical region, the centralized controller notifies other wireless stations to discontinue using wireless channels used by those higher priority incumbent entities.

### BRIEF DESCRIPTION OF EXAMPLES

In the national spectrum R&D plan, Dynamic Spectrum Sharing (DSS) is defined as adaptive coexistence using techniques that enable multiple electromagnetic spectrum users to operate on the same frequencies in the same geographic area without causing harmful interference to other users (in cases where such other users have an expectation of protection from harmful interference) by using capabilities that can adjust and optimize electromagnetic spectrum usage in real time or near-real time, consistent with defined regulations and policies for a particular spectrum band.

So-called DSS is being considered for frequencies in the 3.1-3.45 GHz range, the 3.1 GHz band. The band is currently used by many different types of federal systems, including fixed, mobile, and airborne wireless communication systems.

This disclosure includes the observation that adjustment of spectrum (wireless channel) usage in real time or near real time is needed to protect wireless systems that may be moving fast, such as airborne wireless systems, as well as for systems that would monitor interference into their systems and provide feedback on adjustment of spectrum usage by systems sharing their frequencies.

Spectrum usage may be controlled through a web portal, sensor, or spectrum controller, or a combination of them.

Some commercial systems can be configured to connect to the spectrum controller in real time or near real time to quickly adjust their spectrum usage. However, the fast connectivity and response time may be a burden for some commercial systems.

Techniques herein include novel ways of providing better use of available wireless channels, without causing or at least reducing a magnitude of wireless interference to high priority entities (such as incumbent entities) operating in a network environment.

More specifically, as discussed herein, a communication management resource (such as a wireless bandwidth management resource or the suitable entity) monitors use of wireless bandwidth by at least one entity in a network environment. The at least one entity may include an incumbent entity having a highest assigned priority to use available wireless bandwidth. The communication management resource can be configured to receive a first request from a first wireless station for allocation of a portion of the wireless bandwidth. The portion may be a wireless channel. In response to receiving the first request, the communication management resource allocates the first wireless station use of a first portion of the wireless bandwidth depending on a communication configuration implemented by the first wireless station to communicate with the bandwidth management resource. In one example, the communication configuration (a.k.a., configuration settings of the first wireless station) controls a rate at which the first wireless station communicates with the wireless bandwidth management resource for continued allocation of the first portion of the wireless bandwidth.

In accordance with further examples, the communication management resource can be configured to allocate the first portion of the wireless bandwidth based on a wireless power level at which the first wireless station requests to wirelessly transmit in the network environment using the first portion of the wireless bandwidth.

In yet further examples, the communication configuration implemented by the first wireless station specifies or controls a heartbeat rate of the first wireless station communicating with the bandwidth management resource for grant of continued allocation of the first portion of the wireless bandwidth. In other words, the first wireless station allocated the wireless channel may communicate at a periodic rate to receive further grant of using the first wireless channel. In response to a respective further grant of using the allocated wireless channel because the communication management resource or other suitable entity determines that continued grant of the wireless channel to the first wireless station will not cause interference to the incumbent entity, the communication management resource grants use of the wireless channel for a time duration equal to or greater than the periodic rate of the wireless station generating the continued requests to use the wireless channel.

It is further noted that the wireless bandwidth can be configured to include multiple wireless channels; the first portion of the wireless bandwidth allocated to the first wireless station may be a first wireless channel of the multiple wireless channels. In one example, the at least one entity includes a first entity such as a so-called incumbent entity assigned a first priority level to use the wireless bandwidth. The first wireless station may be assigned a second priority level, where the second priority level is lower in a tiered hierarchy than the first priority level. The wireless bandwidth management resource can be configured to allocate the portion of wireless bandwidth based on one or more parameter such as: i) a region of wireless coverage associated with the first wireless station wirelessly transmitting communications using the first portion of bandwidth such as a first wireless channel, ii) an estimated speed associated with the first entity or protection region associated with the first entity moving about the network environment, and so on.

As further discussed herein, the at least one entity in the network environment includes a first entity assigned a first priority level to use the wireless bandwidth. The first wireless station may be assigned a second priority level, where the second priority level is lower in a tiered hierarchy than the first priority level.

Still further, allocation of bandwidth to a respective wireless station may include the wireless base station management resource: predicting a first behavior of the at least one high priority entity (such as incumbent entity) using the bandwidth at a particular time of day; predicting a second behavior of multiple wireless stations requesting use of the bandwidth at the particular time of day, the multiple wireless stations including the first wireless station; and assigning the first wireless station use of the first portion of the wireless bandwidth based on the predicted first behavior and the predicted second behavior.

Yet further, allocation of bandwidth to a respective wireless bandwidth management resource station: receiving first location information indicating a location of the first wireless station in the network environment; via the monitored use of the wireless bandwidth by the at least one entity in different regions of the network environment, predicting an amount of future wireless interference associated with the first wireless station wirelessly transmitting communications via the first portion of the wireless bandwidth within a channel grant time as indicated by the communication configuration; and assigning the first wireless station use of the first portion of the wireless bandwidth in response to detecting that the predicted amount of future wireless interference is below a threshold level.

In yet further examples, the wireless bandwidth manager resource: receives a second request from a second wireless station for use of a portion of the wireless bandwidth; and in response to receiving the second request, allocates the second wireless station use of a second portion of the wireless bandwidth based on a communication configuration associated with the second wireless station communicating with the bandwidth management resource to use the second portion of the bandwidth.

According to further examples, as previously discussed, the first portion of the wireless bandwidth may be a first wireless channel. To monitor use of the wireless bandwidth by the at least one entity, the bandwidth management resource can be configured to: estimate a movement of a first entity itself or corresponding protection region associated with the first entity in the network environment, where the first entity communicating in the network environment uses the first wireless channel. The wireless bandwidth management resource allocates the first wireless station use of the first wireless channel in response to detecting a non-interference condition associated with use of the first wireless channel by the first wireless station.

In still further examples, the wireless bandwidth manager resource allocates use of the first portion of the wireless bandwidth based on a combination of an estimated region of wireless coverage associated with the first wireless station using the first portion of the wireless bandwidth and a moving protection area (a.k.a., protection region) associated with the at least one entity.

Techniques as discussed herein are useful over conventional techniques. For example, implementation of the system and corresponding operations as discussed herein provides better use of a respective wireless channels to convey data between wireless stations without causing undesirable interference to one or more wireless stations having highest priority rights to use the one or more shared wireless channels.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium or any computer readable hardware storage medium on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are also directed to a method, system, computer program product, etc., that supports operations as discussed herein.

One example as further discussed herein includes a computer readable storage medium and/or system having instructions stored thereon. The instructions, when executed by the computer processor hardware, cause the computer processor hardware (such as one or more co-located or disparately processor devices or hardware) to: monitor use of wireless bandwidth by at least one entity in a network environment; receive a first request from a first wireless station for use of a portion of the wireless bandwidth; and in response to receiving the first request, allocate the first wireless station use of a first portion of the wireless bandwidth depending on a communication configuration implemented by the first wireless station to communicate with the bandwidth management resource. Allocation of the first portion of the wireless bandwidth may be dependent on other factors as discussed herein.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing wireless connectivity in a network environment. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more inventive concepts as described herein can be implemented and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a wireless network environment and control of one or more wireless base stations with respect to the operation of one or more high priority wireless stations as discussed herein.

FIG. 2 is an example diagram illustrating implementation of different communication rates between wireless base stations and a respective bandwidth allocation management resource as discussed herein.

FIG. 3 is an example diagram illustrating allocation of wireless channels to multiple wireless base stations based upon monitoring of movement associated with protection areas associated with multiple incumbent entities as discussed herein.

FIG. 4 is an example diagram illustrating status information associated with multiple wireless channels and corresponding incumbent entities as discussed herein.

FIG. 5 is an example diagram illustrating status information associated with multiple wireless channels and corresponding incumbent entities as discussed herein.

FIG. 6 is an example diagram illustrating status information associated with multiple wireless channels and corresponding incumbent entities as discussed herein.

FIG. 7 is an example diagram tracking of a moving protection area associated with an incumbent wireless station with respect to use of the wireless channel by a wireless base station as discussed herein.

FIG. 8 is an example diagram tracking of a moving protection area associated with an incumbent wireless station with respect to use of the wireless channel by a wireless base station as discussed herein.

FIG. 9 is an example diagram tracking of a moving protection area associated with an incumbent wireless station with respect to use of the wireless channel by a wireless base station as discussed herein.

FIG. 10 is an example diagram illustrating example computer hardware and software operable to execute operations as discussed herein.

FIG. 11 is an example diagram illustrating a method as discussed herein.

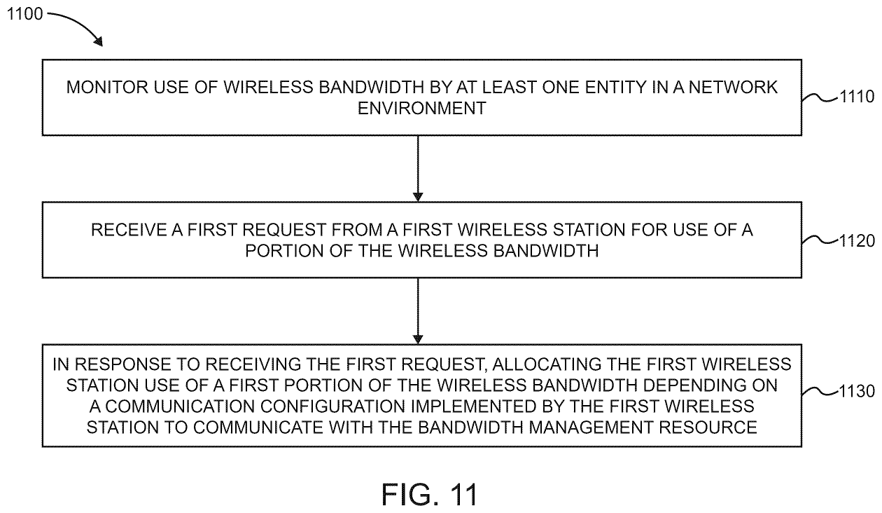

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DESCRIPTION OF EXAMPLES

As previously discussed, a communication management resource (such as a spectrum access system or other suitable entity) monitors use of wireless bandwidth and wireless interference in a network environment.

The communication management resource as discussed herein can be configured to receive a first request from a first wireless station for allocation of a portion (such as a channel) of the wireless bandwidth. The portion may be a wireless channel or other suitable wireless bandwidth portion. In response to receiving the first request, the communication management resource learns of a communication configuration implemented by the first wireless station to communicate with the bandwidth management resource. In one example, the communication configuration indicates a rate at which the first wireless station is configured to communicate with the wireless bandwidth management resource for continued allocation of the first portion (a.k.a., first wireless channel) of the wireless bandwidth. Based at least in part on the communication configuration of the first wireless station, the communication management resource allocates bandwidth such as one or more channels for use by the first wireless station.

Assume that the communication management resource allocates a first wireless channel for use by the first wireless station. Assume further that a high priority entity (wireless station) has higher priority rights to use the first wireless channel than the first wireless station. In one example, the first wireless station (such as a wireless base station) communicates a rate value at which the wireless base station is configured to repeatedly communicate with the communication management resource for continued allocation of the first wireless channel. Based at least in part on the received rate value assigned to the first wireless station as well as the locations of the first wireless station and estimated moving protection region associated with the high priority entity, the communication management resource controls use of the first wireless channel by the wireless base station so that it does not cause interference with the high priority entity.

If the communication management resource detects, based on the estimated location and direction of travel of the high priority entity, that the first wireless station will cause wireless interference to the high priority entity prior to a time of a next scheduled channel grant request transmitted from the first wireless station, the communication management resource adjusts operation of the first wireless station using the first wireless channel accordingly.

That is, if the communication management resource determines that use of the first wireless channel by the first wireless station will cause wireless interference to the high priority entity prior to the end of a channel grant time, the communication management resource either revokes use of the first wireless channel by the first wireless station or at least reduces the allocated wireless transmit power level associated with the first wireless station using the first wireless channel.

Alternatively, if the communication management resource determines that use of the first wireless channel by the first wireless station will not cause wireless interference to high priority entity or corresponding moving protection region associated with the high priority entity prior to the end of a channel grant time, the communication management resource notifies the first wireless station that it is provided further granted use of first wireless channel.

In accordance with a further example, a base station and a spectrum controller determine the pace or request rate at which the first wireless base station communicates with the spectrum controller for transmit grants for a shared spectrum (communication period or rate value), e.g., every 5 minutes, 2 minutes, or other time duration. The rate value controls a scheduled time duration between the first wireless base station communicating continued requests to the spectrum controller for continued use the allocated wireless channel

The spectrum controller can be configured to further receive protection requirements associated with the incumbent entities having higher priority rights than the first wireless base station, some of which change in real time or near real time (i.e., at a fast pace). The spectrum controller can be configured to provide a so-called transmit grants or wireless channel usage to the first wireless base station in a manner as to protect all incumbents (a.k.a., incumbent entities) in a respective network environment.

The grant period (i.e., scheduled time of how long the grant of a respective one or more wireless channel to the first wireless base station is valid) may be greater than or equal to the communication period at which the first wireless base station periodically communicates heartbeat messages (to maintain continuous grant of a wireless channel) with the communication spectrum controller.

It is noted that a transmit grant (such as allocation of wireless bandwidth including one or more wireless channels) may further include control settings such as transmit power, frequency range, duration of grant, etc.

Different wireless base stations in a respective network environment may be served by a spectrum controller, where the different wireless base stations are configured to support different communication and grant periods.

As discussed herein, the spectrum controller can be configured to determine transmit grants for a wireless base station to eliminate or minimize the likelihood of interference to incumbent entities without frequent grant changes.

In one example, this may be achieved as follows:
1. Information about incumbent entities or protection environment
   a) Some incumbent entities may be mobile and move about different geographic areas. Their protection requirements may change frequently due to their mobility (and of the sensor located with them) or during startup phase. However, spectrum controller may protect the incumbent entities and corresponding protection areas associated with the incumbent entities based on aggregate interference modeled to a grid of points in their range of locations.
2. Prediction using data analytics
   a) In one example, computer processor hardware such as a communication management resource is implemented to predict aggregate interference to incumbents (a.k.a., incumbent entities) and determine bandwidth grants to lower priority wireless base stations in cases where it is determined that there would be no interference by the lower priority wireless base stations to the incumbent entities.
3. Interference margin
   a) Even though incumbent protection requirements may be changing in near real time, commercial radios may be allowed to use bandwidth grants that meet protection requirements with a margin or buffer allowing them to continue using the grants for longer durations.
4. A combination of the above techniques

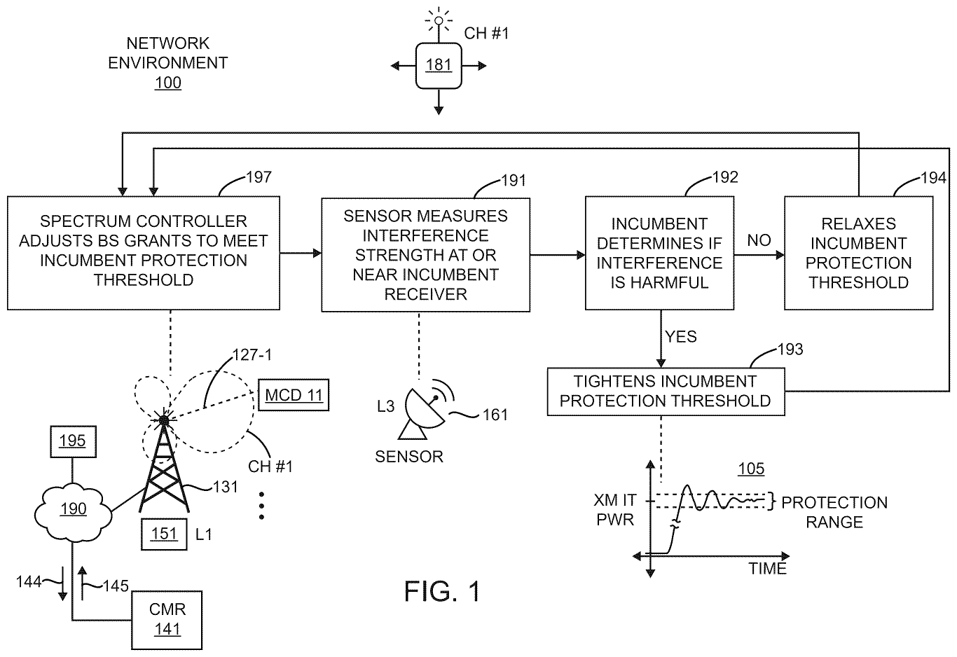

Now, more specifically, FIG. 1 is an example diagram illustrating a wireless network environment and operation of one or more wireless stations with respect to operation of one or more high priority wireless stations (a.k.a., incumbent entities) as discussed herein.

As shown in FIG. 1, the network environment 100 includes wireless base station 131, remote network 190, communication management resource 141, mobile communication device MCD11 (a.k.a., user equipment), wireless sensor 161, and communication management resource 141 (such as an allocation management resource or other suitable entity).

In general, the wireless base station 131 resides at the location L1 (such as a fixed location) in the network environment 100. The wireless base station 131 can be configured to support wireless connectivity to any number of mobile communication devices.

Via communications over the wireless communication link 127-1, the wireless base station 131 provides the mobile communication device MCD11 wireless access to the remote network 190. For example, the wireless communication link 127-1 supports conveyance of wireless communications transmitted from the mobile communication device MCD 11 through a combination of the wireless base station 131 and the remote network 190 to the server resource 195 (or any other communication device in the remote network 190). In an opposite direction, the wireless communication link 127-1 supports conveyance of wireless communications transmitted from the server resource 195 (or any other communication device in the remote network 190) through a combination of the network 190 and the wireless base station 131 to the mobile communication device MCD11.

Note that the wireless base station 131 can be configured to communicate with any number of mobile communication devices present in the network environment 100.

Note further that the wireless base station 131 can be configured to communicate with the mobile communication device MCD11 in accordance with any suitable wireless communication protocol or any suitable wireless channels.

In one example, the communication management resource 141 is an allocation management resource (or spectrum access system) in communication with the wireless base station 131 and any of one or more other wireless base stations in the network environment 100. The communication management resource 141 allocates any of multiple wireless channels in a wireless band (such as a so-called CBRS band, where CBRS stands for Citizens Broadband Radio Service) or other suitable wireless bandwidth for use by the wireless base station 131. The CBRS band resides in the 3.5 GHz band, which ranges from 3550 MHz to 3700 MHz.

The one or more wireless channels allocated for use by the wireless base station 131 and corresponding mobile communication device MCD11 may be licensed wireless channels (a.k.a., PAL channels) or general access channels (a.k.a., GAA channels).

Use of the wireless channels by the different wireless stations (wireless base station 131, mobile communication device MCD 11, etc.) in the network environment 100 is contingent upon availability.

In one example, the use of the wireless channels is based on a tiered hierarchy in which the high priority wireless station 181 (such as a so-called incumbent entity) has the highest priority rights over any wireless base stations or mobile communication devices operated in the network environment 100. This means that the lower priority wireless stations such as including wireless base station 131 and mobile communication device MCD11 must not transmit wireless signals that would cause interference to the high priority wireless station 181.

In other words, as discussed herein, in one example, the wireless base station 131 and mobile communication device MCD11 are prevented from transmitting signals at such high wireless power levels that it causes wireless interference to the high priority wireless station 181 such as incumbent entity moving about the network environment 100.

When the wireless station 181 uses wireless channel 1 (a.k.a., CH #1 or CH1) and is in close proximity to the wireless base station 131 and mobile communication device MCD11, because the wireless station 181 has highest priority settings in the network environment 100, the wireless base station 131 and corresponding mobile communication device MCD11 must discontinue use of that wireless channel.

Thus, in one example, the high priority wireless station 181 is a so-called incumbent entity having higher priority rights to use wireless channels in the network environment 100 over any other lower priority wireless stations such as wireless base station 131, mobile communication device MCD11, etc.

As previously discussed, the wireless base station 131 and mobile communication device MCD11 may be required to discontinue transmitting all wireless communications in a wireless channel used by the high priority wireless station 181. Techniques herein enable coexistence of the wireless base station 131 and mobile communication device 121 using a wireless channel also used by the high priority wireless station 181.

As further shown, the wireless base station 131 is configured with the communication settings 151. At a minimum, the communication settings 151 can be configured to control a rate R1 at which the wireless base station 131 communicates with the communication management resource 141 for continued allocation of one or more wireless channels.

Note that the resources as discussed herein can be implemented in any suitable manner. For example, the communication management resource 141 can be implemented as communication management hardware, communication management software, or a combination of communication manager hardware and communication management software; wireless base station 131 can be implemented as wireless base station hardware, wireless base station software, or a combination of wireless base station hardware and wireless base station software; mobile communication device MCD11 can be implemented as mobile communication device hardware, mobile communication device software, or a combination of mobile communication device hardware and mobile communication device software; wireless sensor 161 at location L3 can be configured as wireless sensor hardware, wireless sensors software, or a combination of wireless sensor hardware and wireless sensor software; high priority wireless station 181 can be implemented as high priority wireless station hardware, high priority wireless station software, or a combination of high priority wireless station hardware and high-priority wireless station software; and so on.

Further in this example, assume that the wireless base station 131 communicates over the network 190 such as via communications 144 for allocation of a wireless channel to communicate in the network environment 100.

As further discussed herein, the communication management resource 141 (a.k.a., wireless bandwidth management resource) monitors use of wireless bandwidth such as the wireless channel #1 used by the wireless station 181 (such as incumbent entity having highest priority rights to use the wireless channel #1). Additionally, the communication management resource 141 receives a request from the wireless base station 131 to use a portion of wireless bandwidth (such as multiple wireless channels) managed by the communication management resource 141.

Prior to allocation of a portion of available wireless bandwidth to the wireless base station 131, the communication management resource 141 receives notification of configuration settings 151 associated with the wireless base station 131. Depending on a communication configuration implemented by the first wireless station to communicate with the bandwidth management resource 141 as indicated by the configuration settings 151, and in response to receiving the request for allocation of wireless bandwidth, via communications 145 the communication management resource 141 allocates the wireless base station 131 use of a first portion of the wireless bandwidth such as wireless channel #1.

In one example as further shown in FIG. 1, the communication management resource 141 (such as a spectrum controller) can be configured to control a wireless power level associated with the wireless base station 131 and the mobile communication device MCD11 using the wireless channel #1.

For example, in processing operation #191, the sensor 161 located at the location L3 can be configured to measure interference strength associated with use of wireless channel #1 at or near the wireless station 181. Note that the wireless sensor 161 may be located at the location L3 or co-located with the wireless station 181. When the wireless sensor 161 detects that use of the wireless channel #1 by the wireless station 131 and the mobile communication device MCD 11 causes wireless interference to the wireless station 181 above a threshold level, the communication management resource 141 reduces a wireless power level of the wireless base station 131 and the mobile communication device MCD11 using the wireless channel #1.

More specifically, in processing operation #192, the wireless station 181 or other suitable entity determines whether the wireless interference caused by the wireless base station 131 and/or mobile communication device MCD11 is harmful or not to the wireless station 181 having highest priority.

Processing flow continues at operation #193 if the wireless station 181 or other suitable entity determines that wireless interference caused by the wireless base station 131 using wireless channel #1 is above a threshold level such as protection range are threshold level in graph 105. In such an instance, in processing operation #193, the communication management resource 141 such as spectrum controller adjusts the grant of use of wireless channel #1 to the wireless base station 131 such that detected wireless interference associated with use of the channel #1 falls within an incumbent protection threshold. In this example, adjustment of the granted use of wireless channel #1 may include the communication management resource 141 notifying the wireless base station 131 that it must communicate at a lower wireless power level in processing operation #193.

Alternatively, processing flow continues at operation #194 if the wireless station 181 or other suitable entity determines that wireless interference caused by the wireless base station 131 using wireless channel #1 is below a threshold level such as protection range in graph 105. In such an instance, in processing operation #194, the communication management resource 141 such as spectrum controller adjusts the grant of use of wireless channel #1 to the wireless base station 131 such that it falls within an incumbent protection threshold. In this example, adjustment of the granted use of wireless channel #1 may include the communication management resource 141 notifying the wireless base station 131 that it may wirelessly transmit at a higher wireless power level.

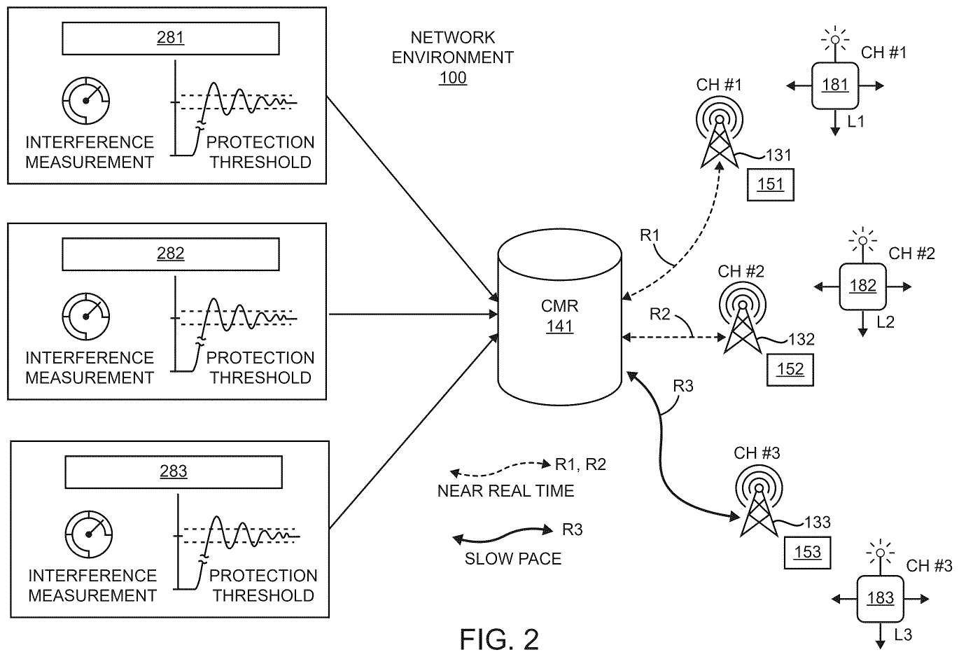

FIG. 2 is an example diagram illustrating implementation of different communication rates between wireless base stations and a respective bandwidth allocation management resource as discussed herein.

In the example shown in FIG. 2, the network environment 100 includes multiple incumbent entity such as wireless station 181 using wireless channel #1, wireless station 182 using wireless channel #2, wireless station 183 using wireless channel #3, etc.

Each of the incumbent entity wireless stations 181, 182, 183, etc., moves about the network environment 100.

It is noted that the communication management resource 141 such as spectrum access system or other suitable entity can be configured to monitor wireless interference caused by non-incumbent entities using one or more wireless channels. The communication management resource 141 proactively adjust use of those wireless channels (such as wireless transmit levels) by the different wireless base stations 131, 132, 133, etc., such that the wireless stations 181, 182, 183, etc., do not cause unwanted interference to the incumbent entity wireless stations.

As further shown in FIG. 2, each of the wireless base stations can be configured with respective configuration settings controlling how often the respective wireless base station communicates with the communication management resource 141 for continued allocation of a respective wireless channel.

More specifically, in accordance with the configuration settings 151, the wireless base station 131 is configured to transmit repeated heartbeat communications (request for continued use of an allocated wireless channel #1) to the communication management resource 141 so that the communication management resource 141 provides continued granted use of the wireless channel 1 by the wireless base station 131 and corresponding communication devices.

Assume that the configuration settings 151 support a communication rate of R1 (such as every 5 minutes) for periodic channel grant/request messages. As further discussed herein, the communication management resource 141 can be configured to monitor the estimated location of the wireless station 181 or corresponding protection area associated with the wireless station 181 and corresponding trajectory of the wireless station 181 over time.

In this instance, the communication management resource 141 can be configured to selectively allocate and control use of the wireless channel #1 by the wireless base station 131 and corresponding mobile communication devices based on the communication rate R1 and the estimated trajectory (direction) and speed of the mobile communication device 181. Given the communication rate of 5 minutes (R1), the communication management resource 141 determines from the trajectory and speed of the wireless station 181 whether it is likely that the use of the wireless channel #1 by the base station 131 will cause interference to the wireless station 181 within the 5 minute timeframe of a channel grant. If so, the communication management resource 141 can be configured to adjust usage of the wireless channel #1 by the wireless base station 131 so that it does not cause wireless interference to the wireless station 181. If not, the communication management resource 141 can be configured to allow continued usage of the wireless channel #1 by the wireless base station 131.

In a similar manner as previously discussed, the communication management resource 141 controls use of wireless channel #2 by the wireless base station 132 and corresponding mobile communication devices such that the use of the wireless channel #2 does not interfere with any of the wireless stations 181, 182, 183, etc.

Assume that the configuration settings 152 assigned to the wireless base station 132 support a communication rate of R2 (such as every 1 minute). As further discussed herein, the communication management resource 141 can be configured to monitor the estimated location of the wireless station 181 or corresponding protection area and corresponding trajectory of the wireless station and protection area over time. In this instance, the communication management resource 141 can be configured to selectively allocate and control use of the wireless channel #2 by the wireless base station 132 and corresponding mobile communication devices based on the communication rate R2 and the estimated trajectory and speed of the mobile communication device 1 8 2. Given the communication rate of 1 minute (R2), the communication management resource 141 determines from the trajectory and speed of the wireless station 182 whether it is likely that the use of the wireless channel #2 by the base station 132 will cause interference to the wireless station 182. If so, the communication management resource 141 can be configured to adjust usage of the wireless channel #2 by the wireless base station 132 so that it does not cause wireless interference to the wireless station 182. If not, the communication management resource 141 can be configured to allow continued usage of the wireless channel #2 by the wireless base station 132.

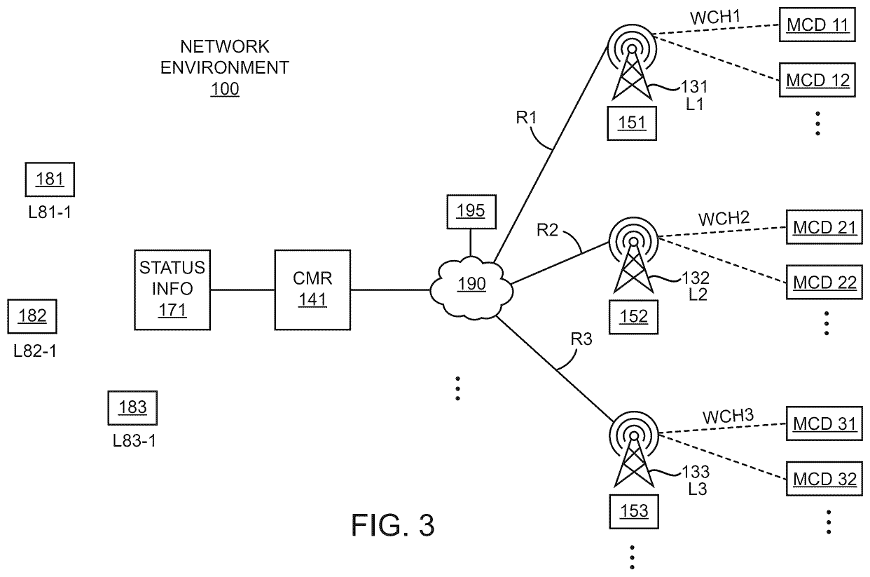

FIG. 3 is an example diagram illustrating allocation of wireless channels to multiple wireless base stations based upon monitoring of movement associated with multiple incumbent entities and corresponding protection areas as discussed herein.

In the example shown in FIG. 3, the network environment 100 includes multiple incumbent entity such as wireless station 181 using wireless channel #1, wireless station 182 using wireless channel #2, wireless station 183 using wireless channel #3, etc.

The wireless base station 131 is allocated use of the wireless channel #1 to support wireless communications with the mobile communication devices MCD11, and MCD12, etc.

The wireless base station 132 is allocated use of the wireless channel #2 to support wireless communications with the mobile communication devices MCD21, and MCD22, etc.

The wireless base station 133 is allocated use of the wireless channel #3 to support wireless communications with the mobile communication devices MCD31, and MCD32, etc.

As previously discussed, the communication management resource 141 such as spectrum access system or other suitable entity can be configured to monitor wireless interference caused by non-incumbent entities one or more wireless channels and proactively adjust use of those wireless channels (such as wireless transmit levels) by the different wireless base stations 131, 132, 133, etc., such that the wireless stations 181, 182, 183, etc., do not experience unwanted interference from the wireless base stations.

Note that the communication management resource 141 can be located anywhere in the network environment 100.

As further shown in FIG. 3, and as previously discussed, each of the wireless base stations can be configured with respective configuration settings controlling how often the respective wireless base station communicates with the communication management resource 141 for continued allocation of a respective wireless channel.

More specifically, in accordance with the configuration settings 151, the wireless base station 131 is configured to transmit repeated heartbeat communications (request for continued use of the wireless channel #1) to the communication management resource 141 so that the communication management resource 141 provides continued granted use of the wireless channel #1 by the wireless base station 131 and corresponding communication devices. Assume in this example, that the wireless base station 131 communicates with the communication management resource 141 every 5 minutes (as indicated by the configuration settings 151) to receive additional respective grant of use of the wireless channel #1 for another 5 minutes. At the end of the five-minute grant time, the wireless base station 131 communicates again with the communication management resource 141 for continued grant of the wireless channel #1 for another 5 minutes.

The wireless base station 131 can be configured to communicate the grant request rate value R1 of 5 minutes to the communication management resource 141. Alternatively, the communication management resource 141 determines the rate R1 associated with the wireless base station 131 based on monitoring a duration of time between each of the received grant request communicated from the wireless base station 131 over the network 190 to the communication management resource 141.

In either instance, the communication management resource 141 determines that the grant request rate R1 of the wireless base station 131 is 5 minutes.

In addition to the communication management resource 141 learning of the grant request rate R1 assigned to the wireless base station 131 wherein the request rate R1 indicates that the wireless base station 131 schedules and transmits a respective grant request for continued use of the wireless channel 1 every 5 minutes, the wireless base station 131 can be configured to notify the communication management resource 141 of one or more specific wireless channels that the wireless base station 131 would like to be granted. Yet further, in addition to the rate R1 and request for allocation of specific desired channels, the wireless base station 131 can be configured to notify the communication management resource 141 of a desired wireless power level at which the wireless base station 131 would like to be allowed to wirelessly transmit respective wireless signals to the corresponding multiple mobile communication devices MCD11, MCD12, etc.

In a similar manner, the wireless base station 132 can be configured to communicate the grant request rate value R2 (as indicated by the configuration settings 152) of 1 minute to the communication management resource 141. Alternatively, the communication management resource 141 determines the rate R2 based on monitoring a duration of time between each of the received grant request communicated from the wireless base station 132 over the network 190 to the communication management resource 141. In either instance, the communication management resource 141 determines that the grant request rate R2 of the wireless base station 132 is 1 minute.

Further in this example, the communication management resource 141 monitors or estimates a current location of each of the wireless stations 181, 182, 183, etc. As previously discussed, the locations of the wireless stations can be determined in any suitable manner such as sensors 161 located on the ground at different fixed locations. The sensors are used to detect an amount of wireless interference and generally the location of each of the wireless stations 181, 182, 183, etc. Alternatively, interference sensors can be co-located with each of the incumbent entity wireless stations to detect the amount interference.

In one example, based on the detected wireless interference at each of the different locations in the network environment 100 using one or more sensors at fixed locations, the communication management resource 141 produces a respective status information 171 indicating approximate locations of each of the incumbent entity wireless stations (a.k.a., wireless station 181, wireless station 182, wireless station 183, etc.).

At time T1, the wireless station 181 is located at location L81-1; at time T1, the wireless station 182 is located at location L82-1; at time T1, the wireless station 183 is located at location L83-1.

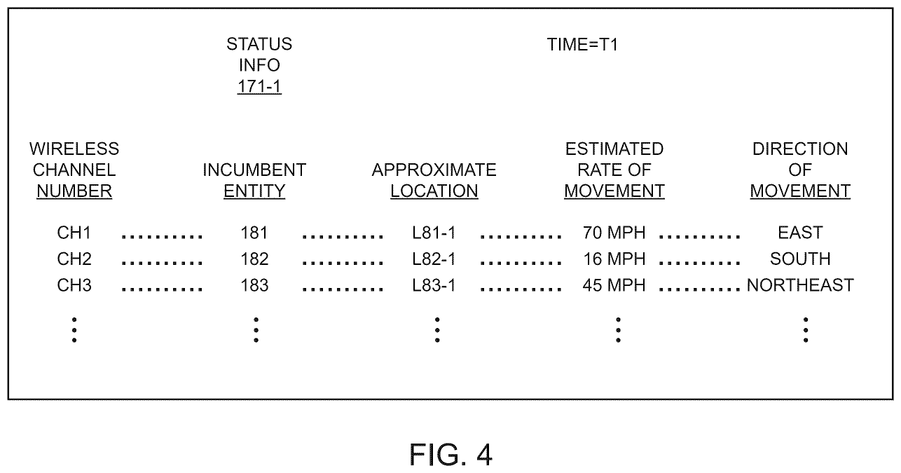

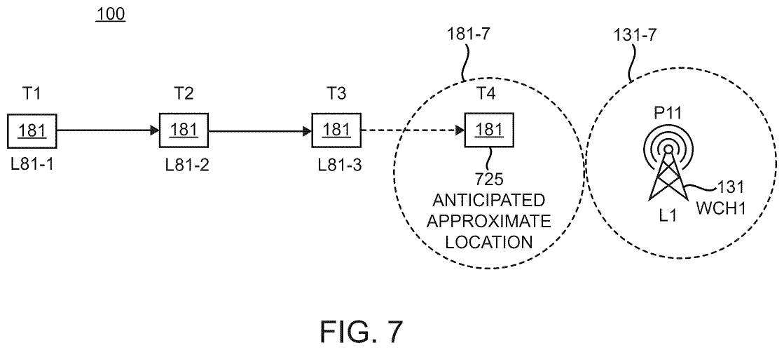

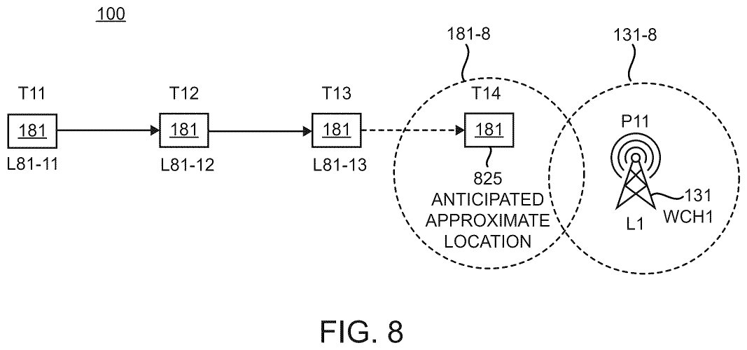

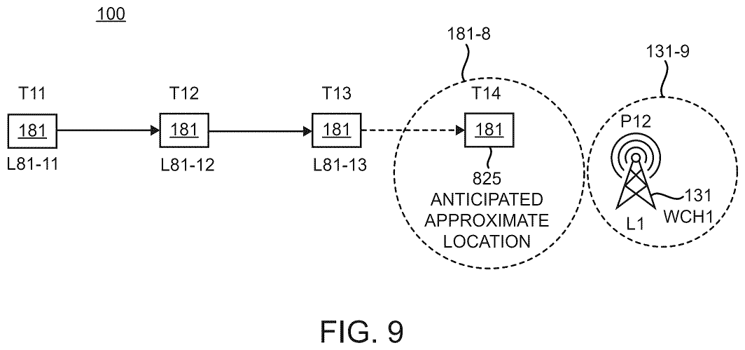

Examples of the status information 171 as generated by the communication management resource 141 or other suitable entity at different instances of time T1, T2, T3, etc., is shown in FIGS. 4-6. A plot of the approximate locations associated with each of the incumbent entity wireless station 181 and protection region associated with the wireless station 181 with respect to the wireless base station 131 is shown in FIG. 7. FIG. 8 is an example diagram illustrating use of the rate value R1 associated with the wireless base station 131 and the approximate 4 estimated location of the incumbent entity wireless station 181 (and corresponding protection region) over time to determine whether the wireless channel #1 can be allocated for use by the wireless base station 131 for a next grant period of 5 seconds. FIG. 9 is an example diagram illustrating adjustment of the power level associated with the wireless base station 131 transmitting wireless communications based on rate value R1 associated with the wireless base station 131 and the approximate location of the incumbent entity wireless station 181 over time to determine whether the wireless channel #1 can be allocated for use by the wireless base station 131 for each next grant period of 5 seconds.

FIG. 4 is an example diagram illustrating status information generated by the communication management resource or other suitable entity as discussed herein.

In this example, at or around time T1, the communication management resource 141 generates status information 171-1 to indicate that the wireless channel #1 is used by the incumbent entity wireless station 181, which resides approximately at location L81-1 and which is traveling at an estimated rate of 70 miles per hour in the easterly direction.

In a similar manner, the communication management resource 141 keeps track of information associated with the incumbent entity wireless station 182, incumbent entity wireless station 183, etc.

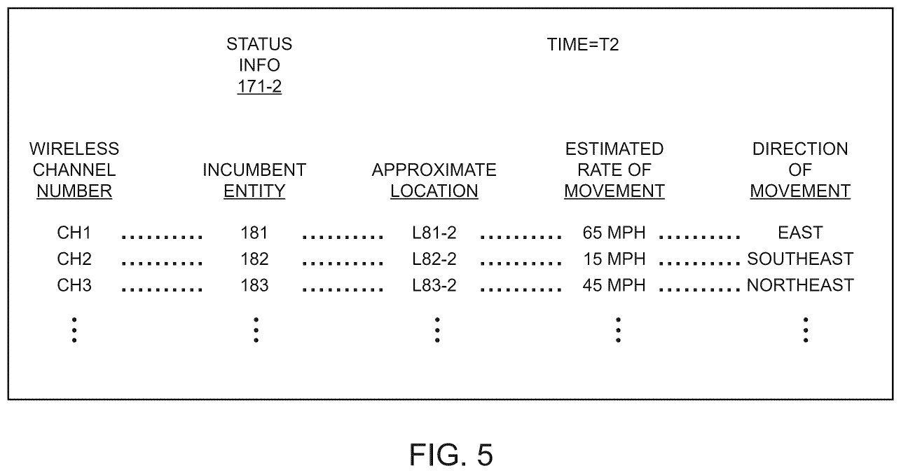

FIG. 5 is an example diagram illustrating status information generated by the communication management resource or other suitable entity as discussed herein.

Further in this example, at or around time T2, the communication management resource 141 generates status information 171-2 to indicate that the wireless channel #1 is used by the incumbent entity wireless station 181, which resides approximately at location L81-2 and which is traveling at an estimated rate of 65 miles per hour in the easterly direction at or around time T2.

In a similar manner, the communication management resource 141 keeps track of information associated with the incumbent entity wireless station 182, incumbent entity wireless station 183, etc.

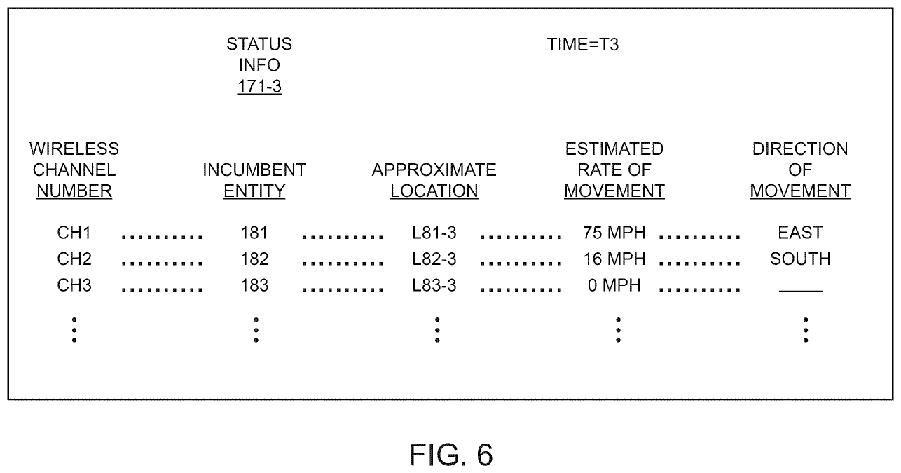

FIG. 6 is an example diagram illustrating status information generated by the communication management resource or other suitable entity as discussed herein.

Yet further in this example, at or around time T3, the communication management resource 141 generates status information 171-3 to indicate that the wireless channel #1 is used by the incumbent entity wireless station 181, which resides approximately at location L81-3 and which is traveling at an estimated rate of 75 miles per hour in the easterly direction.

In a similar manner, the communication management resource 141 keeps track of information associated with the incumbent entity wireless station 182, incumbent entity wireless station 183, etc.

The communication management resource 141 can be configured to receive a first request from the wireless base station 131 for allocation of a portion (such as a channel) of the wireless bandwidth. The portion may be a wireless channel or other suitable wireless bandwidth portion. In response to receiving the first request, the communication management resource 141 learns of a communication configuration implemented by the first wireless station to communicate with the bandwidth management resource. In one example, the communication configuration indicates a rate R1 of 5 seconds or other suitable value at which the first wireless station is configured to communicate with the wireless bandwidth management resource for continued allocation of the first portion (a.k.a., first wireless channel) of the wireless bandwidth. Based at least in part on the communication configuration of the wireless base station 131 as indicated by the configuration settings 151, the communication management resource 141 allocates bandwidth such as one or more channels for use by the first wireless station.

Assume that the communication management resource 141 allocates a first wireless channel for use by the wireless base station 131. The high priority entity (wireless station 181) has higher priority rights to use the first wireless channel than the wireless base station 131. In one example, the wireless base station 131 communicates a rate value R1 at which the wireless base station is configured to repeatedly communicate with the communication management resource for continued allocation of the first wireless channel.

Based on the received rate value assigned to the first wireless station as well as the locations of the wireless base station 131 and estimated location of the high priority wireless station 181 corresponding protection region, the communication management resource 141 controls use of the first wireless channel by the wireless base station 131 so that it does not cause interference with the high priority entity wireless station 181. If the communication management resource detects based on the estimated location and direction of travel of the high priority entity and corresponding protection area that the wireless base station 131 will cause wireless interference to the high priority entity wireless station 181 prior to a time of the next scheduled channel request from the first wireless station, the communication management resource 141 adjusts operation of the wireless base station 131 using the first wireless channel accordingly.

That is, if the communication management resource determines that use of the first wireless channel by the first wireless station will cause wireless interference to the high priority entity prior to the end of a channel grant time which corresponds to a time of the next scheduled request from the first wireless station for continued use of the first wireless channel, the communication management resource either revokes use of the first wireless channel by the first wireless station or at least reduces the allocated wireless transmit power level associated with the first wireless station using the first wireless channel.

Alternatively, if the communication management resource determines that use of the first wireless channel by the first wireless station will cause wireless interference to high priority entity prior to the end of a channel grant time which corresponds to a time of the next scheduled request from the first wireless station for continued use of the first wireless channel, the communication management resource notifies the first wireless station that it is provided further granted use of first wireless channel for at least the time duration associated with the rate value.

FIG. 7 is an example diagram illustrating a change in location of the incumbent entity wireless station over time with respect to a wireless base station as discussed herein.

As previously discussed, the wireless station 181 and corresponding protection region is estimated as being at location L81-1 at or around time T1; the wireless station 181 and corresponding protection region is estimated as being at location L81-2 at or around time T2; the wireless station 181 and corresponding protection region is estimated as being at location L81-3 at or around time T3.

Note that the protection region around the wireless station 181 is a geographical region or geographical area surrounding the respective wireless station 181 as it moves through the network environment 100.

Assume that the wireless base station 131 would like to be granted continued use of use the wireless channel #1 to communicate with corresponding mobile communication devices at the power level P11 at or around time T3. This may include the wireless base station 131 communicating the power level P11 to the communication management resource 141. In such an instance, at or around time T3, the wireless base station 131 communicates a request to the communication management resource 141 for the use of wireless channel #1 at wireless power level P11.

As previously discussed, the communication management resource 141 or other suitable entity can be configured to estimate the approximate location of the wireless station 181 and corresponding protection area (181-7) around 5 seconds (rate R1=5 seconds) after receiving the request for use of wireless channel #1 at or around time T3. Based on the prior tracking information as indicated by status information 171, the communication management resource 141 estimates the direction and distance of the wireless station 181 corresponding protection region with respect to the current location L81-3 of the wireless station 181 where the wireless station 181 will potentially be at time T4.

As previously discussed, as indicated by the multiple instances of status information 171, the wireless station 181 was traveling (consistently) in an easterly direction at a speed of around 75 miles per hour in an easterly direction with respect to location L81-3 at or around time T4. To determine the anticipated location 725 of the wireless station 181 and the corresponding protection area 181-7 at or around time T4, the communication management resource 141 multiplies the speed (approximately 75 miles per hour) of the wireless station 181 by the time duration of 5 seconds (R1). In this example, time T4 is equal to time T3 plus 5 seconds. Time T4 is the time in which the wireless base station 131 is scheduled to transmit a next grant request for allocation of wireless channel #1. The grant of wireless channel #1 by the wireless base station 131 is for 5 seconds. Based on the analysis by the communication management resource 141 or other suitable entity as discussed herein, the communication management resource 141 determines whether or not the wireless channel #1 can be granted for another 5 seconds to the wireless base station 131 without the wireless base station 131 interfering with the wireless station 181 or the protection area (181-7) because the wireless station 131 has a higher priority ranking than the wireless base station 131 as previously discussed.

In this example, because the wireless station 181 is anticipated to be at the location 725 with a corresponding protection area (one anyone-7) at or around time T4, which resides outside of the region of wireless coverage 131-7 associated with the wireless base station 131 wirelessly transmitting at the power level P11, the communication management resource 141 grants the wireless base station 131 use of the wireless channel #1 to transmit the power level P11 for the next 5 seconds because no interference is detected or anticipated.

It is further noted that the communication management resource 141 can be configured to allocate use of the wireless channel #1 by the wireless base station 131 based on the buffer region such as region of wireless coverage or protection area 181-7 181-7. For example, because the wireless station 181 is anticipated to be at the location 725 with corresponding protection area 181-7 at or around time T4, the communication management resource 141 determines that the region of wireless coverage 181-7 associated with the wireless station 181 resides outside of the region of wireless coverage 131-7 associated with the wireless base station 131 wirelessly transmitting at the power level P11. This means that allocation of the wireless channel #1 at a power level P11 between time T3 and time T4 most likely will not result in the wireless base station 131 interfering with the wireless station 181. In such an instance, the communication management resource 141 grants the use of wireless channel #1 by the wireless base station 131 at power level P11

FIG. 8 is an example diagram illustrating a change in location of the incumbent entity wireless station over time with respect to a wireless base station as discussed herein.

Further in this example, based on wireless interference feedback, the wireless station 181 is estimated as being at location L81-11 at or around time T11; the wireless station is estimated as being at location L81-12 at or around time T12=T11+5 seconds; the wireless station 181 is estimated as being at location L81-13 at or around time T13=T12+5 seconds.

Assume that the wireless base station 131 would like to the granted continued use of use the wireless channel #1 to communicate with corresponding mobile communication devices at the power level P11 at or around time T13. In such an instance, at or around time T13, the wireless base station 131 communicates a request to the communication management resource 141 for the use of wireless channel #1 at wireless power level P11.

As previously discussed, the communication management resource 141 or other suitable entity can be configured to estimate and track the approximate location of the wireless station 181 and corresponding protection area 181-8 around 5 seconds (rate R1=5 seconds) after receiving the request for use of wireless channel #1 at or around time T13. Based on the prior tracking information as indicated by status information 171, the communication management resource 141 estimates the direction and distance with respect to the current location L81-13 and corresponding protection area 181-8 of the wireless station 181 where the wireless station 181 will be at time T14.

Assume that the status information 171 indicates that the wireless station 181 was traveling in an easterly direction at a speed of 75 miles per hour in an easterly direction with respect to location L81-13 at or around time T13. To determine the anticipated location 825 and corresponding protection area 181-8 of the wireless station 181 at or around time T14, the communication management resource 141 multiplies the speed (75 miles per hour) of the wireless station 181 and time T13 by the time duration of 5 seconds (R1). In this example, time T14 is equal to time T13 plus 5 seconds. Time T14 is the time in which the wireless base station 131 is scheduled to transmit a next grant request. Based on the analysis by the communication management resource 141 or other suitable entity as discussed herein, and assuming that the wireless station 181 continues in the same easterly direction, the communication management resource 141 determines whether or not the wireless channel #1 can be granted for another 5 seconds to the wireless base station 131 without the wireless base station 131 interfering with the wireless station 181 because the wireless station 131 has a higher priority ranking than the wireless base station 131 as previously discussed.

In this example, assuming that there is no change in direction, in the worst case scenario, because the wireless station 181 and corresponding protection area 181-8 is potentially anticipated to be at the location 825 at or around time T14, which resides inside of or at least overlaps partially with the region of wireless coverage 131-8 associated with the wireless base station 131 wirelessly transmitting at the power level P11, the communication management resource 141 does not grant the wireless base station 131 use of the wireless channel #1 to transmit the power level P11 for the next 5 seconds with respect to time T13. In other words, in this instance, the communication management resource 141 determines that the wireless base station transmitting at the power level P 11 may cause wireless interference to the wireless station 181 if the wireless station 181 continues at the same easterly direction and speed of around 70 miles per hour. The communication management resource can be configured to revoke use of the wireless channel 1 by the wireless base station 131 because it is anticipated that the continued use of the wireless channel #1 by the wireless base station will cause or potentially cause wireless interference to the wireless station 181 before time T14 because of the prior trajectory of the wireless station 181.

It is further noted that the communication management resource 141 can be configured to revoke use of the wireless channel #1 by the wireless base station 131 based on the buffer region such as region of wireless coverage or protection area 181-8. For example, because the wireless station 181 is anticipated to be at the location 825 with a corresponding protection area of 181-8 at or around time T14, the communication management resource 141 determines that the region of wireless coverage or protection area 181-8 associated with the wireless station 181 resides inside of or at least partially overlaps with the region of wireless coverage 131-8 associated with the wireless base station 131 wirelessly transmitting at the power level P11. This means that allocation of the wireless channel #1 at a power level P11 between time T13 and time T14 most likely will result in the wireless base station 131 interfering with the wireless station 181. In such an instance, the communication management resource 141 revokes the use of wireless channel #1 by the wireless base station 131 at power level P11.

FIG. 9 is an example diagram illustrating power level adjustment to a wireless base station so that it does not cause interference to a respective incumbent entity wireless station as discussed herein.

It is noted that the anticipated wireless interference caused by the wireless base station 131 to the wireless station 181 may be due to the high power level P11 as previously discussed in FIG. 8. As further shown in FIG. 9, one way to resolve allowing the wireless base station 131 to continue use of the wireless channel #1 may be to reduce the wireless power level of the wireless base station 131 using the wireless channel #1 from P11 to P12.

In other words, as shown in FIG. 9, if the power level of the wireless base station 131 using wireless channel #1 is reduced to power level P12 instead of power level P11 as requested by the wireless base station 131, and where power level P12 is less than power level P11 to reduce the size of the respective region of wireless coverage 131-9 associated with use of the wireless channel #1 by the wireless base station 131, the communication management resource 141 notifies the wireless base station 131 to use the power level P12 so that it does not cause interference to the wireless station 181. As shown in FIG. 9, use of the wireless channel #1 at the power level P12 results in the region of wireless coverage 131-9 residing substantially outside of the protection area 181-8. In such an instance, the wireless base station 131 does not wirelessly interfere with the wireless station 181. The communication management resource 141 allocates use of wireless channel #1 to the wireless base station 131 at a wireless power level of P12.

### Further Examples and Summary—

In one example, the communication management resource 141 monitors use of the wireless bandwidth by the different incumbent entity such as wireless stations 181, 182, 183, etc. The communication management resource 141 receives a first request from the wireless base station 131 to use a portion of the wireless bandwidth such as wireless channel #1. In response to receiving the request from the wireless base station 131 and potentially additional information such as a requested wireless power level P11, communication rate R1, etc., the communication management resource 141 determines whether it is able to allocate wireless channel 1 to the wireless base station 131. As previously discussed, the allocation of the wireless channel #1 to the wireless base station 131 is contingent upon a communication configuration such as communication rate R1 supported by the wireless base station 131 to communicate with the communication management resource 141.

In a further example, the communication configuration such as configuration settings 151 indicating a respective control rate R1 at which the wireless base station 131 communicates with the communication management resource 141 (a.k.a., wireless bandwidth management resource) for a continued allocation of the first portion of the wireless bandwidth (a.k.a., wireless channel 1).

As previously discussed, allocation of the wireless channel #1 to the wireless base station 131 may be contingent upon the wireless power level P11 at which the wireless base station 131 requests to wirelessly transmit communications in the network environment 100 using the wireless channel #1.

Further, as previously discussed, the configuration settings 151 can be configured to include a communication configuration such as a heartbeat rate R1 of the wireless base station 131 communicating with the communication management resource 141 for continued allocation of the wireless channel #1. The wireless station 181 has the highest priority level in a tiered hierarchy. The wireless base station 131 is assigned a priority level lower than the highest priority level in a tiered hierarchy. Allocation of the wireless channel #1 to the wireless base station 131 may be based on one or more of the following: i) a region of wireless coverage associated with the wireless base station 131 wirelessly transmitting using the first wireless channel, ii) an estimated speed and/or direction associated with the wireless station 181 moving about the network environment 100, iii) an estimated protection region associated with the wireless station 181, iv) a rate R1 at which the wireless base station 131 is configured to repeatedly request allocation of the wireless channel 1, rate R1 corresponds the channel grant rate, etc.

Note further that the communication management resource 141 can be configured to: predict a first operation of the wireless station 181 using the bandwidth at a particular time of day; predict a second operation of multiple wireless base stations requesting use of the bandwidth at the particular time of day; and assign the wireless base station 131 use of the channel #1 based on the predicted first operation and the predicted second operation.

In a further example, allocation of the wireless channel #1 to the wireless base station 131 may include the communication management resource 141: receiving first location information associated with the wireless station 181, where the location information indicates a location and/or protection region associated with the wireless station 181; via the monitored use of the wireless bandwidth wireless channel 1 by the wireless station 181 in different regions of the network environment, predicting an amount of future wireless interference (such as indicated by intersection of the protection region or geographical region 181-7, 181-8, etc., and the region of wireless coverage 131-7, 131-8, 131-9, etc.) associated with the wireless base station 131 wirelessly transmitting communications via the wireless channel 1 within a channel grant time (5 seconds) associated with a communication rate R1 as indicated by the communication configuration (a.k.a., configuration settings 151); and assigning the wireless base station 131 use of the wireless channel #1 in response to detecting that the predicted amount of future or anticipated wireless interference caused by the wireless base station 131 to the corresponding protection area indicated by protection region 181-7, 181-8, etc., is below a threshold level.

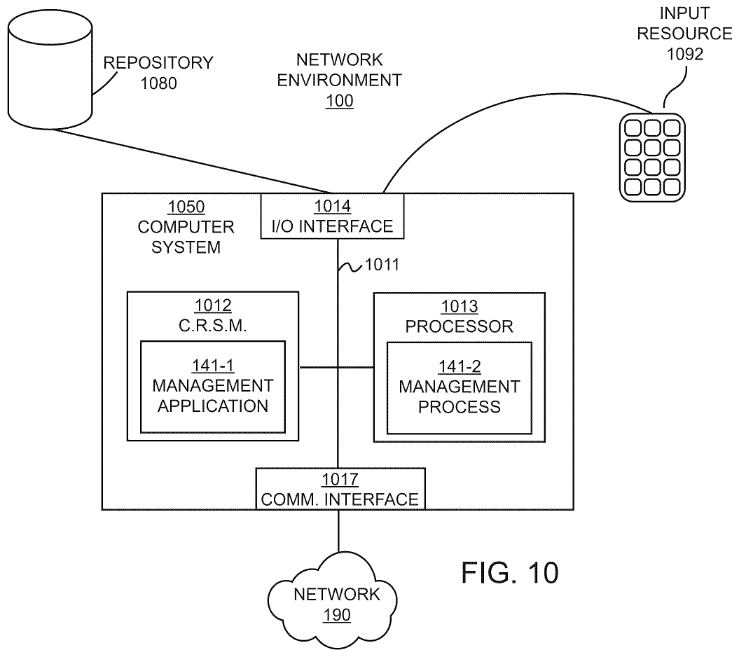

FIG. 10 is an example block diagram of a computer system for implementing any of the operations as discussed herein.

Note that any of the resources (such as communication management resource 141, communication device MCD11, wireless base station 131, wireless station 181, etc.) as discussed herein can be configured to include computer processor hardware and/or corresponding executable instructions to carry out the different operations as discussed herein.

For example, as shown, computer system 1050 of the present example includes interconnect 1011 coupling computer readable storage media 1012 such as a non-transitory type of media, or computer readable storage hardware (which can be any suitable type of resource in which digital information can be stored and or retrieved), a processor 1013 (computer processor hardware), I/O interface 1014, and a communications interface 1017.

I/O interface(s) 1014 supports connectivity to repository 1080 and input resource 1092.

Computer readable storage medium 1012 such as computer readable hardware can be any hardware storage device such as memory, optical storage, hard drive, floppy disk, etc. In one example, the computer readable storage medium 1012 stores instructions and/or data.

As shown, computer readable storage media 1012 can be encoded with communication management application 141-1 in a respective wireless station to carry out any of the operations as discussed herein.

During operation of one example, processor 1013 accesses computer readable storage media 1012 via the use of interconnect 1011 in order to launch, run, execute, interpret or otherwise perform the instructions in management application 141-1 stored on computer readable storage medium 1012. Execution of the communication management application 141-1 produces communication management process 141-2 to carry out any of the operations and/or processes as discussed herein.

Those skilled in the art will understand that the computer system 1050 can include other processes and/or software and hardware components, such as an operating system that controls allocation and use of hardware resources to execute the management application 141-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1050 may reside at any location or can be included in any suitable resource in any network environment to implement functionality as discussed herein.

Functionality supported by the different resources will now be discussed via flowchart 1200 in FIG. 12. Note that the steps in the flowchart below can be executed in any suitable order.

FIG. 12 is a flowchart 1200 illustrating an example method according to examples herein. Note that there will be some overlap with respect to concepts as discussed above.

In processing operation 1210, the communication management resource 141 monitors use of wireless bandwidth such as one or more wireless channels by one or more in common entities in a network environment.

In processing operation 1220, the communication management resource 141 receives a first request from a first wireless station for use of a portion of the wireless bandwidth.

In processing operation 1230, in response to receiving the first request, the communication management resource 141 allocates the first wireless station use of a first portion of the wireless bandwidth depending on a communication configuration implemented by the first wireless station to communicate with the bandwidth management resource.

Note again that techniques herein are well suited to provide improved wireless connectivity amongst wireless stations and reduce wireless interference to high priority entities. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this example has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

I claim:

1. A method comprising:
via a wireless bandwidth management resource:
monitoring use of wireless bandwidth by a first wireless station in a network environment;
receiving a first request from a second wireless station for use of a portion of the wireless bandwidth; and
in response to receiving the first request, allocating the second wireless station use of a first portion of the wireless bandwidth depending on a communication configuration implemented by the second wireless station to communicate with the bandwidth management resource.

2. The method as in claim 1, wherein the communication configuration is operative to control a rate at which the second wireless station communicates with the wireless bandwidth management resource for continued allocation of the first portion of the wireless bandwidth.

3. The method as in claim 1, wherein allocating the second wireless station use of the first portion of the wireless bandwidth is further based on a wireless power level at which the second wireless station requests to wirelessly transmit using the first portion of the wireless bandwidth.

4. The method as in claim 1, wherein the communication configuration is a heartbeat rate of the second wireless station communicating with the bandwidth management resource for allocation of the first portion of the wireless bandwidth.

5. The method as in claim 4, wherein the wireless bandwidth includes multiple wireless channels; and
wherein the first portion of the wireless bandwidth allocated to the second wireless station is a first wireless channel of the multiple wireless channels.

6. The method as in claim 5, wherein the first wireless station is assigned a first priority level to use the wireless bandwidth;
wherein the second wireless station is assigned a second priority level, the second priority level being lower in a tiered hierarchy than the first priority level; and
wherein allocating the second wireless station use of the first wireless channel is based on: i) a region of wireless coverage associated with the second wireless station wirelessly transmitting using the first wireless channel, and ii) an estimated speed associated with the first wireless station moving about the network environment.

7. The method as in claim 1, wherein the first wireless station is assigned a first priority level to use the wireless bandwidth; and
wherein the second wireless station is assigned a second priority level, the second priority level being lower in a tiered hierarchy than the first priority level.

8. The method as in claim 1, wherein allocating the first wireless station includes:
predicting a first operation of the first wireless station using the bandwidth at a particular time of day;
predicting a second operation of multiple wireless stations requesting use of the bandwidth at the particular time of day, the multiple wireless stations including the second wireless station; and
assigning the second wireless station use of the first portion of the wireless bandwidth based on the predicted first operation and the predicted second operation.

9. The method as in claim 1, wherein allocating the second wireless station use of the first portion of the wireless bandwidth includes:
receiving first location information indicating a location associated with the first wireless station in the network environment;
via the monitored use of the wireless bandwidth by the first wireless station in different regions of the network environment, predicting an amount of future wireless interference associated with the second wireless station wirelessly transmitting communications via the first portion of the wireless bandwidth within a channel grant time associated with a communication rate as indicated by the communication configuration; and
assigning the second wireless station use of the first portion of the wireless bandwidth in response to detecting that the predicted amount of future wireless interference is below a threshold level.

10. The method as in claim 1 further comprising:
via the wireless bandwidth management resource:
receiving a second request from a third wireless station for use of a portion of the wireless bandwidth; and
in response to receiving the second request, allocating the third wireless station use of a second portion of the wireless bandwidth based on a communication configuration associated with the third wireless station communicating with the bandwidth management resource to use the second portion of the bandwidth.

11. The method as in claim 1, wherein the first portion of the wireless bandwidth is a first wireless channel;
wherein monitoring use of the wireless bandwidth by the first wireless station in the network environment includes: estimating movement of a protection region associated with the first wireless station in the network environment, the first wireless station communicating in the network environment using the first wireless channel.

12. The method as in claim 11 further comprising:
allocating the second wireless station use of the first wireless channel based on the estimated movement of the protection region within a time duration as specified by the communication configuration.

13. The method as in claim 1, wherein allocation of use of the first portion of the wireless bandwidth to the second wireless station is further based on an estimated first region of wireless coverage associated with the second wireless station using the first portion of the wireless bandwidth with respect to a second region of wireless coverage associated with future anticipated use of the first portion of the wireless bandwidth by the first wireless station.

14. A system comprising:
communication management hardware operative to:
monitor use of wireless bandwidth by a first wireless station in a network environment;
receive a first request from a second wireless station for use of a portion of the wireless bandwidth; and
in response to receiving the first request, allocate the second wireless station use of a first portion of the wireless bandwidth depending on a communication configuration implemented by the second wireless station to communicate with the bandwidth management resource.

15. The method as in claim 14, wherein the communication configuration is operative to control a rate at which the second wireless station communicates with the wireless bandwidth management resource for continued allocation of the first portion of the wireless bandwidth.

16. The method as in claim 14, wherein allocation of the second wireless station use of the first portion of the wireless bandwidth is further based on a wireless power level at which the second wireless station requests to wirelessly transmit using the first portion of the wireless bandwidth.

17. The method as in claim 14, wherein the communication configuration is a heartbeat rate of the second wireless station communicating with the bandwidth management resource for allocation of the first portion of the wireless bandwidth.

18. The method as in claim 17, wherein the wireless bandwidth includes multiple wireless channels; and
wherein the first portion of the wireless bandwidth allocated to the second wireless station is a first wireless channel of the multiple wireless channels.

19. The method as in claim 18, wherein the first wireless station is assigned a first priority level to use the wireless bandwidth;
wherein the second wireless station is assigned a second priority level, the second priority level being lower in a tiered hierarchy than the first priority level; and
wherein allocation of the second wireless station use of the first wireless channel is based on: i) a region of wireless coverage associated with the second wireless station wirelessly transmitting using the first wireless channel, and ii) an estimated speed associated with the first wireless station moving about the network environment.

20. The method as in claim 14, wherein the first wireless station is assigned a first priority level to use the wireless bandwidth; and
wherein the second wireless station is assigned a second priority level, the second priority level being lower in a tiered hierarchy than the first priority level.

21. The method as in claim 14, wherein the communication management resource is further operative to:
predict a first operation of the first wireless station using the bandwidth at a particular time of day;
predict a second operation of multiple wireless stations requesting use of the bandwidth at the particular time of day, the multiple wireless stations including the second wireless station; and
assign the second wireless station use of the first portion of the wireless bandwidth based on the predicted first operation and the predicted second operation.

22. The method as in claim 14, wherein the communication management hardware is further operative to:
receive first location information indicating a location associated with the first wireless station in the network environment;
via the monitored use of the wireless bandwidth by the first wireless station in different regions of the network environment, predict an amount of future wireless interference associated with the second wireless station wirelessly transmitting communications via the first portion of the wireless bandwidth within a corresponding channel grant time duration; and
assign the second wireless station use of the first portion of the wireless bandwidth in response to detecting that the predicted amount of future wireless interference is below a threshold level.

23. The method as in claim 14, wherein the communication management hardware is further operative to:
receive a second request from a third wireless station for use of a portion of the wireless bandwidth; and
in response to receiving the second request, allocate the third wireless station use of a second portion of the wireless bandwidth based on a communication configuration associated with the third wireless station communicating with the bandwidth management resource to use the second portion of the bandwidth.

24. The method as in claim 14, wherein the first portion of the wireless bandwidth is a first wireless channel; and
wherein the communication management hardware is further operative to: estimate movement of a protection region associated with the first wireless station in the network environment, the first wireless station communicating in the network environment using the first wireless channel.

25. The method as in claim 24, wherein the communication management hardware is further operative to:
allocate the second wireless station use of the first wireless channel based on the estimated movement of the protection region within a time duration as specified by the communication configuration.

26. The method as in claim 14, wherein allocation of the second wireless station use of the first portion of the wireless bandwidth to the second wireless station is further based on an estimated first region of wireless coverage associated with the second wireless station using the first portion of the wireless bandwidth with respect to a second region of wireless coverage associated with anticipated use of the first portion of the wireless bandwidth by the first wireless station.

27. Computer-readable storage hardware having instructions stored thereon, the instructions, when carried out by computer processor hardware, cause the computer processor hardware to:
monitor use of wireless bandwidth by at least one entity in a network environment;
receive a first request from a first wireless station for use of a portion of the wireless bandwidth; and
in response to receiving the first request, allocate the first wireless station use of a first portion of the wireless bandwidth depending on a communication configuration implemented by the first wireless station to communicate with the bandwidth management resource.
